(19) United States
(12) Patent Application Publication
(10) Pub. No.: US 2013/0281647 A1
(43) Pub. Date: Oct. 24, 2013

(54) Method for Making a Nanometer enhanced Thermo-durable Thermosetting Polyester Material

(71) Applicants: Chang-Lun Lee, Taichung City (TW); Chih-Sheng Cheng, Tainan City (TW); Shu-Fen Chen, Taichung City (TW); Tsung-Shan Ho, Taichung City (TW)

(72) Inventors: Chang-Lun Lee, Taichung City (TW); Chih-Sheng Cheng, Tainan City (TW); Shu-Fen Chen, Taichung City (TW); Tsung-Shan Ho, Taichung City (TW)

(73) Assignee: Chung-Shan Institute of Science and Technology, Armaments, Bureau, Ministry of National Defense, Taoyuan County (TW)

(21) Appl. No.: 13/454,216

(22) Filed: Apr. 24, 2012

(51) Int. Cl. C08F 230/08; B82Y 40/00; B82Y 30/00

(52) U.S. Cl. 526/279; 977/700; 977/897

(57) ABSTRACT

A method is used to make a nanometer enhanced thermo-durable thermosetting polyester material. The method includes the steps of providing prepolymeric viscous liquid and curing the prepolymeric viscous liquid. The prepolymeric viscous liquid includes: a polyester prepolymer that includes an unsaturated vinyl group of low molecular weight, a functional polyester oligomer that includes an unsaturated vinyl group, a polyester prepolymer that includes an unsaturated vinyl group associated with layered silicates, and a polymerizable monomer that includes a vinyl group. To cure the prepolymeric viscous liquid, a catalyst and an accelerator are used. Thus, there is provided a highly cross-linked three-dimensional thermosetting polyester/layered silicate nanometer material.

### BACKGROUND OF INVENTION

1. Field of Invention

The present invention relates to a method for making a nanometer enhanced thermo-durable thermosetting polyester material and, more particularly, to a method for making a nanometer enhanced thermo-durable thermosetting polyester material that exhibits improved heat resistance, molecular chain rigidity, cross-link density, thermal stability and mechanical properties.

2. Related Prior Art

High-performance resins such as bismaleimide, polyimide and epoxy are used in the aerospace industry. They exhibit excellent heat resistance and mechanical properties. They however require long periods for curing and are expensive.

Thermosetting unsaturated polyester is the most popular resin in the composite industry. The market value of thermosetting unsaturated polyester is about 66% of the market value of all resins in the composite industry. Thermosetting unsaturated polyester exhibits excellent workability, corrosion resistance, chemical resistance, mechanical properties, hydrolysis resistance, and lightweight. Thermosetting unsaturated polyester requires a short period of time for curing and is inexpensive in comparison with the high-performance resins used in the aerospace industry.

Hence, thermosetting unsaturated polyester is often used in yachts, boats, chemical tanks, industrial pipes and storage towers where heat resistance is not the primary concern. For example, in a yacht, hydrolysis resistance and moisture isolation are important while the operation temperature does not exceed 100° C.

Thermosetting unsaturated polyester is not good for industrial usages such as chemical absorption towers and high-temperature chimneys where materials must stand 160° C. Moreover, thermosetting unsaturated polyester is not good for high-temperature molding machines and heating appliances that require heat resistance, oxidization resistance, thermal insulation and low costs. The high-temperature molding machines may be hot presses, plastic injection molding machines, sealing and packing machines and wood presses. The heating appliances may be heaters, stoves, ovens and drivers.

In high-temperature machines, materials must exhibit excellent thermal insulation, strength, corrosion resistance, thermal resistance, heat resistance, durability and workability for protecting parts, simplifying processes, reducing the consumption of energy, and protecting the safety of people. Moreover, the materials must be inexpensive.

The present invention is therefore intended to obviate or at least alleviate the problems encountered in prior art.

### SUMMARY OF INVENTION

It is the primary objective of the present invention to provide a method for making a nanometer enhanced thermo-durable thermosetting polyester material that exhibits improved heat resistance, molecular chain rigidity, cross-link density, thermal stability and mechanical properties.

To achieve the foregoing objectives, the method includes the step of making prepolymeric viscous liquid from a first polyester prepolymer, a functional polyester oligomer, a second polyester prepolymer and a polymerizable monomer. The first polyester prepolymer includes an unsaturated vinyl group of low molecular weight. The functional polyester oligomer includes an unsaturated vinyl group. The second polyester prepolymer includes a layered silicate unsaturated vinyl group. The polymerizable monomer includes the vinyl group. Then, the prepolymeric viscous liquid is cured by using a catalyst and an accelerator, thus providing a highly cross-linked three-dimensional thermosetting polyester/layered silicate nanometer material.

In another aspect, the layered silicate is an organically modified layered silicate.

In another aspect, the layered silicate is an evenly distributed intercalated/exfoliated layered silicate made by in situ intercalation polymerization.

In another aspect, the weight of the layered silicate 1% to 7.5% of the weight of the second polyester prepolymer.

In another aspect, the layered silicate includes layers and spacings between the layers, wherein the thickness of the spacings is 3 to 100 nanometers.

In another aspect, the second polyester prepolymer includes the bisphenol A group and/or the phenol group.

In another aspect, the polymerizable monomer includes styrene, vinyltoluene and/or triallyl cyanurate.

In another aspect, the prepolymeric viscous liquid is made with viscosity of 200 cps to 1800 cps and more preferably 300 cps to 700 cps.

In another aspect, the thermosetting polyester prepolymer is cured at the room temperature or high-temperature.

In another aspect, the thermosetting polyester material is made with a glass transition temperature of at least 160° C.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a flow chart of a first subroutine of a process for making a nanometer enhanced thermo-durable thermosetting polyester material according to the preferred embodiment of the present invention; and

FIG. 2 is a flow chart of a second subroutine of the process for making a nanometer enhanced thermo-durable thermosetting polyester material according to the preferred embodiment of the present invention.

### DETAILED DESCRIPTION OF PREFERRED EMBODIMENT

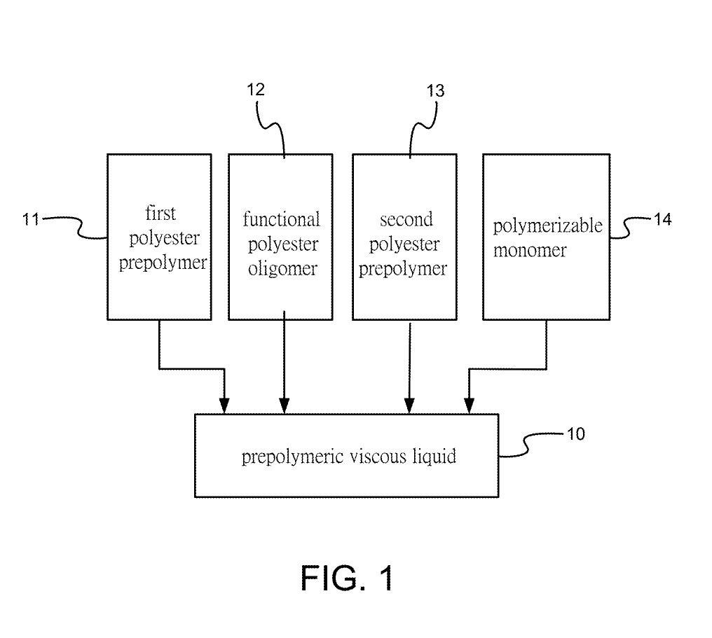

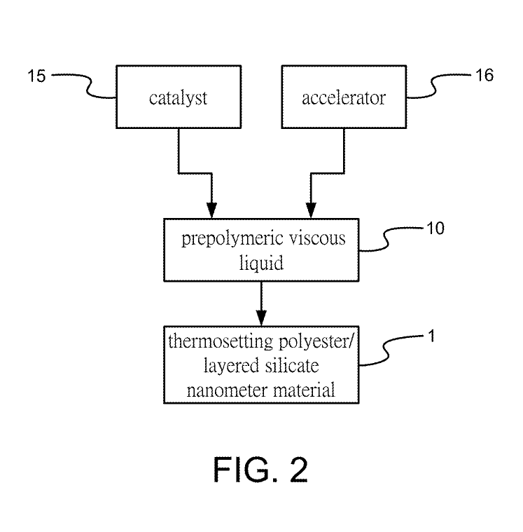

Referring to FIGS. 1 and 2, there is shown a process for making a nanometer enhanced thermo-durable thermosetting polyester material according to the preferred embodiment of the present invention. The process includes a first subroutine shown in FIG. 1 and a second subroutine shown in FIG. 2.

In the first subroutine, prepolymeric viscous liquid 10 is made from a first polyester prepolymer 11, a functional polyester oligomer 12, a second polyester prepolymer 13 and a polymerizable monomer 14. The viscosity of the prepolymeric viscous liquid 10 is preferably 200 cps to 1800 cps and more preferably 300 cps to 700 cps.

The first polyester prepolymer 11 includes an unsaturated vinyl group of low molecular weight.

The functional polyester oligomer 12 includes an unsaturated vinyl group.

The second polyester prepolymer 13 includes a layered silicate unsaturated vinyl group. The layered silicate is an organically modified layered silicate. The layered silicate unsaturated vinyl group includes evenly distributed intercalated/exfoliated layers of silicates made by in situ intercalation polymerization. The weight of the layered silicate is about 1% to 7.5% of the weight of the second polyester prepolymer 13. The spacing between any two adjacent layers of the layered silicate is 3 to 100 nanometers. The second polyester prepolymer 13 includes the bisphenol A group and/or the phenol group.

The polymerizable monomer 14 includes the vinyl group. The polymerizable monomer 14 includes styrene, vinyltoluene and/or triallyl cyanurate.

In the second subroutine, a highly cross-linked three-dimensional thermosetting polyester/layered silicate nanometer material 1 is made by curing the prepolymeric viscous liquid 10 with a catalyst 15 and an accelerator 16. The thermosetting polyester r/layered silicate nanometer material 1 may be cured at the room temperature or high temperature. The glass transition temperature of the thermosetting polyester/layered silicate nanometer material 1 is higher than 160° C.

As nanometer enhanced and chemically modified, the thermosetting polyester/layered silicate nanometer material 1 exhibits the following advantageous features:
1. The pyrolysis temperature and the thermal stability are increased because the thermosetting polyester/layered silicate nanometer material 1 is made by reinforcing the polymer with the nanometer silicate, which includes a long and winding passage between the layers to insulate heat and stop gas.
2. The operation temperature, the heat resistance, the thermal stability and the mechanical properties are increased since the rigidity of the molecular chain and the cross-link density are increased. The thermosetting polyester/layered silicate nanometer material 1 is made by introducing the functional groups of bisphenol A and phenol into the molecular chain to modify the polymer and by including the heat-resistant vinyltoluene.
3. In comparison with the conventional micrometer enhancing materials, the nanometer layered silicate exhibits lightweight and excellent rigidity, strength and thermal insulation. In situ intercalation polymerization can be exerted on thermosetting materials such as unsaturated polyester, epoxy and phenolic resin to provide a nanometer enhanced composite. To this end, a proper polymerizable monomer is used to expand organically modified montmorillonite (“MMT”). Then, cross-linking polymerization is executed. In the expansion, the polymerizable monomer is distributed in the gallery between the layers of the layered silicate. Depending on the extent to which the polymerizable monomer enters the gallery in the layered silicate, a resultant nanometer composite is classified as intercalated, and exfoliated or delaminated.
4. The polymeric chain penetrates and enlarges the gallery between the layers of the layered silicate to provide the sequential intercalated polymer/silicate hybrid material. The polymeric chain penetrates the layered silicate and eventually delaminates the layered silicate to provide the suspended, dispersed, exfoliated polyester/layered silicate nanometer material.
5. It can be used as a thermal durable material operable at 160° C. or higher for a long period of time since the operation temperature is higher in comparison with the conventional polyester.
6. It can be used as an alternative for industrial usage where thermal stability, corrosion resistance, and cost are concerned, in comparison with the high-performance resins such as bismaleimide, polyimide and epoxy used in the aerospace industry, since it is inexpensive and exhibits excellent workability, corrosion resistance, thermal resistance and mechanical properties.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A method for making a nanometer enhanced thermo-durable thermosetting polyester material including the steps of:
making prepolymeric viscous liquid from a first polyester prepolymer 11, a functional polyester oligomer 12, a second polyester prepolymer 13 and a polymerizable monomer 14, wherein the first polyester prepolymer 11 includes an unsaturated vinyl group of low molecular weight, wherein the functional polyester oligomer 12 includes an unsaturated vinyl group, wherein the second polyester prepolymer 13 includes a layered silicate unsaturated vinyl group, wherein the polymerizable monomer 14 includes the vinyl group; and curing the prepolymeric viscous liquid by using a catalyst 15 and an accelerator 16, thus providing a highly cross-linked three-dimensional thermosetting polyester/layered silicate nanometer material.

2. The method according to claim 1, wherein the layered silicate is an organically modified layered silicate.

3. The method according to claim 2, wherein the layered silicate is an evenly distributed intercalated/exfoliated layered silicate made by in situ intercalation polymerization.

4. The method according to claim 3, wherein the weight of the layered silicate 1% to 7.5% of the weight of the second polyester prepolymer.

5. The method according to claim 3, wherein the layered silicate includes layers and spacings between the layers, wherein the thickness of the spacings is 3 to 100 nanometers.

6. The method according to claim 1, wherein the second polyester prepolymer includes at least one functional group selected from the group consisting of the bisphenol A group and the phenol group.

7. The method according to claim 1, wherein the polymerizable monomer includes at least one material selected from the group consisting of styrene, vinyltoluene and triallyl cyanurate.

8. The method according to claim 1, wherein the prepolymeric viscous liquid is made with viscosity of 200 cps to 1800 cps.

9. The method according to claim 8, wherein the prepolymeric viscous liquid is made with viscosity of 300 cps to 700 cps.

10. The method according to claim 1, wherein the thermosetting polyester prepolymer is cured at the room temperature or high-temperature.

11. The method according to claim 1, wherein the thermosetting polyester material is made with a glass transition temperature of at least 160° C.
